(19) United States
(12) Patent Application Publication
(10) Pub. No.: US 2007/0136468 A1
(43) Pub. Date: Jun. 14, 2007

(54) Method for redundant data management in computer networks

(76) Inventor: Richard Ostrcil, Wien (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/593,684

(22) PCT Filed: Mar. 4, 2005
(86) PCT No.: PCT/EP05/50980

§ 371 Date: Sep. 19, 2006

(30) Foreign Application Priority Data
Mar. 23, 2004 (DE) 10 2004 014 195.9

(51) Int. Cl. G06F 15/173

(52) U.S. Cl. 709/226

(57) ABSTRACT

In one aspect, a method for redundant data management in computer networks, wherein data is redundantly stored in a plurality of computers is provided. The data management application programs used for the computers have a coinciding address identification, which the application programs have as component of a virtual sub-network of a computer network. The computers are independent of one another and have routing functions via which the application programs are accessed. The redundant data management is invisible for the user.

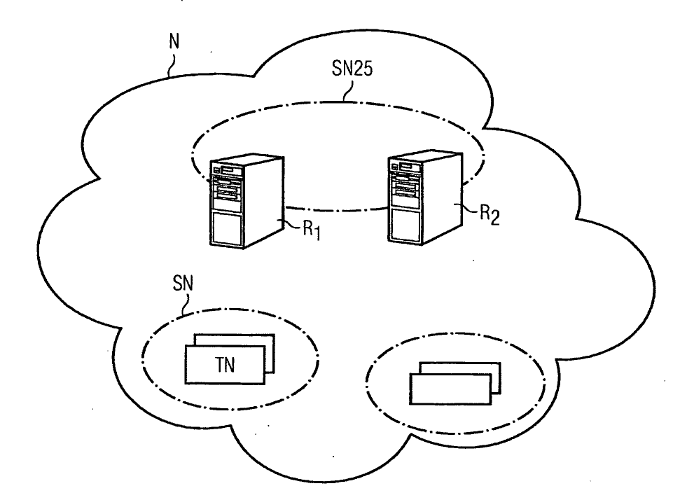

### CROSS REFERENCE TO RELATED APPLICATIONS

This application is the US National Stage of International Application No. PCT/EP2005/050980, filed Mar. 4, 2005 and claims the benefit thereof. The International Application claims the benefits of German application No. 102004014195.9 DE filed Mar. 23, 2004, both of the applications are incorporated by reference herein in their entirety.

### FIELD OF INVENTION

The invention relates to a method for redundant data management in a computer network, in which data is consistently stored in at least two computers of a network.

### BACKGROUND OF INVENTION

Computer networks have developed over the last few years to become a significant means of communication, by means of which a plurality of services is offered. The most well-known computer network in the world is the internet, which denotes the totality of all networks linked together and the networks using the Internet Protocol IP as a transport protocol.

On level 3 of the OSI layer model, the Internet Protocol IP is responsible for the connectionless transport of data from a sender, if necessary over a number of networks, to the recipient, with neither error identification nor error correction taking place.

Transport protocols such as the Transmission Control Protocol TCP or User Datagram Protocol UDP are based on the Internet Protocol.

The Transmission Control Protocol TCP is a connection-oriented transport protocol, which enables a logical, reliable full-duplex-point-to-point link. This ensures that data packets are transmitted in an error free manner and in the desired sequence over an underlying network according to the Internet Protocol IP.

The User Datagram Protocol UDP enables a connectionless point-to-point communication. In this way, the individual data packets (datagrams) are independent of one another. Transmission is not protected. This means that data packets can get lost and that the receive sequence does not have to correspond to the send sequence. Any protection for data transport has, if necessary, to be provided at application level. UDP is generally used for simple services, in which a simple response (a datagram) to a simple request (a datagram) is expected.

One of the most popular applications of the internet is the World Wide Web WWW, which enables easy access to multimedia data on remote WWW servers by way of hyperlinks. The data which could comprise texts, audio sequences, fixed-images and films is viewed and displayed by means of WWW browsers, or local front-end software. The World Wide Web is based on the client/server principle, on which all important applications in the internet, FTP or News as well as WWW, are based.

Applications designed according to the client/server principle use a client program on the user side, said client program exchanging data with a specific service computer in the network, known as the server. In this way, the server is generally responsible for data management, while the client deals with the presentation of this data and interaction with the user. Client and server use a precisely defined protocol for this purpose.

Internet servers are operated either by commercial or non-commercial organizations, such as for instance universities, which offer different online services, such as information services (weather reports, train timetables, message services) and communication services (e-mail, chat, forums), which are realized by means of corresponding application programs.

One essential criterion for the quality of a service offered is the probability, with which a potential user can use the service, the corresponding measured value, resulting from the downtime during a specific observation time, the so-called availability of this service, having a significant influence on the satisfaction of the user and thus on the success of the respective service.

To increase availability, it is often requested that services and/or the respective underlying data should be protected against failures of the relevant hardware components of the computer network, in other words the computer and the links. This is usually achieved by means of redundant data management on several mutually independent computers of a network. To this end, the distribution of incoming messages to different servers by means of a so-called “load balancer” is known from the article “FGPA-based load balancer for Internet Servers, Harik, L., Kayssi, A.” in Microelectronics, The 14^{th} International Conference on 2002-ICM. The “load balancer” thus forms a “single point of failure”, i.e. when the “load balancer” itself fails, none of the subsequent servers can be reached.

### SUMMARY OF INVENTION

The object underlying the invention is to specify an improved method for redundant data management in computer networks.

In accordance with the invention, this is carried out using a method for redundant data management in computer networks, with which data is consistently stored on at least two computers, with the application programs of the at least two computers provided for data management comprising a corresponding address identifier, which features these application programs as a component of a virtual sub-network of a computer network and with the mutually independent computers having routing functions, by means of which the application programs are accessed.

The invention can be used particularly advantageously in computer networks, in which communication is based on the Internet Protocol, and in which the Transmission Control Protocol TCP or the User Datagram Protocol UDP is used as the transport protocol.

It is further favorable if an access ranking for the application programs provided for data management is determined by the corresponding design of the routing function.

### BRIEF DESCRIPTION OF THE DRAWING

The invention is described in more detail with reference to a sole FIGURE, which shows a schematic representation of addressing in an exemplary computer network.

### DETAILED DESCRIPTION OF INVENTION

Addressing in the illustrated computer network N is carried out according to the Internet Protocol version 4 by means of the so-called IP (Internet Protocol) address, which uniquely identifies each network subscriber on level 3 of the OSI layer model, in other words on a logical level.

According to the Internet Protocol version 4, the IP address is a 32 bit word comprising a first area, which is used to address the network and a second area, by means of which the computer in the network is identified.

The size of the two areas is standardized, a distinction being made between 5 classes of IP addresses:

Class A networks with 7 bit network addressing and 24 bits for the subscriber address

Class B networks with 14 bit network addressing and 16 bit subscriber addressing

Class C networks with 21 bit network addressing and 8 bit subscriber address

Class D for addressing within the network with 28 bit subscriber addresses and

Class E reserved for research purposes

The class of the IP address is shown in the leading bits. Addresses of class A can be recognized here in that the leading bit comprises the value 0, class B by the value 10 of the two leading bits, class C by the 110 of the three first bits etc.

The routers of a network require the information about the address class in order to filter out the information about the address of the target network, with the aid of so-called network masks, from the IP address of a target subscriber. Whilst the network addresses are managed globally, the subscriber addresses are managed locally by the respective network operator. Said network operator is then also able to structure its network, by way of subdivision into sub-networks, by corresponding allocation of subscriber addresses, without having to use any additional network numbers. To this end, the subscriber element of the IP address is subdivided into a

sub-network address and the

actual subscriber address.

The IP address is then made up of three parts, comprising the network address, the sub-network address and the actual subscriber address.

A network of address class B can be used as a simple example, in which the IP address comprises the binary number 10 in the leading two bits and a further 14 bits for the address of the network. The subscriber addressing element of 16 bits provided with this network class is in turn subdivided into an 8 bit element for addressing the sub-networks SN1, . . . SN 25, . . . , SN 255 and an 8 bit element for addressing the subscribers TN in the sub-networks. A maximum of 254 sub-networks can thus be addressed with 254 subscribers respectively.

A typical IP address appears as follows in the generally conventional 4 octet notation of IP addresses, in which the individual bytes (8 bits) are shown by means of decimal numerical values and are separated by periods:

172.16.115.54

The address of the network N itself here is 172.16.0.0. This comprises up to 254 sub-networks SN1, . . . SN 25, . . . , SN 255 with the addresses

172.16.1.0, . . . , 172.16.25.254.0

The 254 possible subscribers TN in the sub-network SN 25 with the address 172.16.25.0 then have the following addresses:

172.16.25.1, . . . , 172.16.25.254

In accordance with the invention, the data to be managed in a redundant manner is consistently stored in two mutually independent computers R1, R2 of the network N, with data alignment between the redundant units being ensured using known methods. These methods enable the two computers R1, R2 to belong to a network N of an operator or to different networks of the different operators connected to one another.

A corresponding address identifier is assigned to the associated application programs of the two computers, said address identifier having these application programs as a component of a virtual sub-network SN 25 of a computer network N, such as the number 172.16.25.0. for instance. For the user's purposes, the application program operates on a computer in this sub-network SN 25, for instance on a computer with the address 172.16.25.1.

This virtual sub-network SN 25 is connected logically to the network as a whole via two routers. To this end, the two mutually independent computers R1, R2, which contain inter alia the application programs provided for the redundant and consistent storage of the data, are designed as routers, by means of which access to the application programs, the virtual sub-network, is exclusively available.

The remaining routers of the networks thus contain an indication in their routing tables that addresses of the type 172.16.25.XXX, which relate to the virtual sub-network SN 25, can only be reached via one of the two mentioned routers. In this example, the entry in the routing table of the remaining routers contains the network address 172.16.25.0, the network mask 255.255.255.0, the costs for the path to this sub-network and the interface, by means of which this network N can be reached.

All data packets with these target addresses thus reach one of the two routers and are forwarded from this to the corresponding application program with the respectively associated storage area.

If network N is equipped with a dynamic routing method, as is generally conventional, the next query is automatically routed to the respectively favorable free storage area when one of the two application program is busy. If the two routers, by means of which the virtual sub-network SN 25 can be reached, can be reached via equally expensive paths, a router is chosen at random and a load distribution is thus carried out.

In the case of a network with a static routing method, a corresponding load distribution must be carried out when determining the routing tables.

The specific exemplary embodiment describes the use of the invention in a computer network N with addressing according to IP protocol version 4. The invention can however also be advantageously used for instance with IP protocol version 6. The use of the invention for all customary IP-based transport protocols, such as TCP or UDP, is likewise possible.

When using the TCP protocol, it must be ensured that access is carried out in each instance via a specific router. This can be achieved for instance via the cost functionality of dynamic routing functions.

1.-5. (canceled)

6. A method for a redundant data management in a computer network, comprising:
providing a plurality of mutually independent computers that each have a routing function;
storing redundant data in the plurality of computers;
providing an data management application program for each of the plurality of computers;
assigning an address identifier to each of the programs such that the addresses have a same virtual sub-network; and
accessing the application programs via the network as routers.

7. The method as claimed in claim 6, wherein a communication in the computer network is based on an Internet Protocol.

8. The method as claimed in claim 7, wherein the communication is further based on a Transmission Control Protocol.

9. The method as claimed in claim 7, wherein the communication is further based on a User Datagram Protocol.

10. The method as claimed in claim 7, wherein an access ranking for the programs provided is determined by the routing function.

11. A method for a redundant data management in an Internet Protocol network, comprising:
providing a plurality of mutually independent computers;
storing redundant data in the plurality of computers;
providing a data management application program for each of the plurality of computers;
assigning an address identifier to each of the programs such that the addresses have a same virtual sub-network;
providing a first router within the network; and
accessing one of the application programs via the first router,
wherein the application program appears as a second router to the first router, and
wherein the application accessed is based on a load distribution in the first router.

12. The method as claimed in claim 11, wherein the communication in the network is based on a Transmission Control Protocol.

13. The method as claimed in claim 11, wherein the communication in the network is based on a User Datagram Protocol.
